(19) United States
(12) Patent Application Publication
(10) Pub. No.: US 2025/0162403 A1
(43) Pub. Date: May 22, 2025

(54) VEHICLE AIR FLAP SYSTEM

(71) Applicant: HYUNDAI MOBIS CO., LTD., Seoul (KR)

(72) Inventors: Jang Ho KIM, Yongin-si (KR); Jae Sup BYUN, Yongin-si (KR)

(73) Assignee: HYUNDAI MOBIS CO., LTD., Seoul (KR)

(21) Appl. No.: 18/637,218

(22) Filed: Apr. 16, 2024

(30) Foreign Application Priority Data
Nov. 22, 2023 (KR) 10-2023-0162872

(51) Int. Cl. B60K 11/08

(52) U.S. Cl. CPC B60K 11/085

(57) ABSTRACT

A vehicle air flap system improved to prevent the degradation of the designability of a front side of the vehicle. The vehicle air flap system includes a fixing case including a plurality of inlet holes disposed side by side in a first column and a second column, flap units disposed in the inlet hole of the first column and the inlet hole of the second column, an opening and closing device connected to the flap units and including a first opening and closing unit and a second opening and closing unit which simultaneously rotate the flap units disposed in the inlet hole of the first column and the inlet hole of the second column, and a lighting unit including a light source which is disposed at one side of the flap units and emits light toward the flap units.

### CROSS-REFERENCE TO RELATED APPLICATION

This application claims priority to and the benefit of Korean Patent Application No. 10-2023-0162872, filed on Nov. 22, 2023, the disclosure of which is incorporated herein by reference in its entirety.

### BACKGROUND

### Field of the Invention

The present invention relates to a vehicle air flap system.

### Discussion of Related Art

In order to stably operate various heat exchangers in an engine room of a vehicle, external air should be smoothly supplied to the inside of the engine room. However, when the vehicle travels at high speed, a large amount of external air is introduced at high speed, and thus air resistance becomes very high. Accordingly, there is a problem of decreasing the fuel efficiency of the vehicle.

For solving these problems, air flap systems which help to increase the fuel efficiency by allowing headwind, which passes through a grill installed in front of an engine room of a vehicle and is introduced toward the engine room of the vehicle, to be introduced into the engine room or by blocking the headwind from being introduced into the engine room have been developed.

Such an air flap system may include a housing, which is coupled to a grill and in which an inlet hole through which headwind can pass is formed, and an air flap disposed in the inlet hole formed in the housing.

However, in the conventional air flap system, since an air flap is disposed behind an inlet hole formed in a housing to be stepped with respect to the housing, there is a problem of degrading the designability of a front side of the vehicle.

### SUMMARY OF THE INVENTION

The present invention is directed to providing a vehicle air flap system improved to prevent the degradation of the designability of a front side of a vehicle.

According to an aspect of the present invention, there is a vehicle air flap system including a fixing case including a plurality of inlet holes disposed side by side in a first column and a second column, flap units disposed in the inlet hole of the first column and the inlet hole of the second column, an opening and closing device connected to the flap units and including a first opening and closing unit and a second opening and closing unit which simultaneously rotate the flap units disposed in the inlet hole of the first column and the inlet hole of the second column, and a lighting unit including a light source which is disposed at one side of the flap units and emits light toward the flap units.

When the flap units close the inlet hole of the first column and the inlet hole of the second column, the flap units may be illuminated by the light generated by the lighting unit, and when the flap units open the inlet hole of the first column and the inlet hole of the second column, the flap units may not be illuminated.

The flap units may include a first flap module disposed in the inlet hole of the first column, and the first flap module may include a first lens block which reflects the light generated by the lighting unit, a first cover flap rotatably coupled to the fixing case, and a first support block coupled to the first lens block and the first cover flap to support the first lens block and the first cover flap.

The first lens block may include a plurality of first serration bodies, and each of the first serration bodies may include a 1-1 serration part which is disposed on an unexposed surface and refracts the light emitted by the lighting unit and a 1-2 serration part which is disposed on an exposed surface and emits the light emitted by the lighting unit or the light refracted through the 1-1 serration part.

The flap units may include a second flap module disposed in the inlet hole of the second column, and the second flap module may include a second lens block which refracts the light generated by the lighting unit, a second cover flap coupled to the second lens block and rotatably coupled to the fixing case, and a second support block coupled to the second lens block and the second cover flap to support the second lens block and the second cover flap.

The second lens block may include a plurality of second serration bodies, and each of the second serration bodies may include a 2-1 serration part which is disposed on an unexposed surface and refracts the light emitted by the lighting unit and a 2-2 serration part which is disposed on an exposed surface and refracts the light emitted by the lighting unit or the light refracted through the 2-1 serration part.

The 1-2 serration part of the first serration body may include a plurality of first pattern portions disposed to be spaced apart from each other and a second pattern portion disposed between the plurality of first pattern portions, the 2-2 serration part of the second serration body may include a plurality of third pattern portions and a fourth pattern portion disposed between the plurality of third pattern portions, and the light source of the lighting unit may be disposed to face the second pattern portion and the fourth pattern portion.

The lighting unit may include a first lighting module disposed close to the first flap module, and a second lighting module disposed close to the second flap module, wherein the first lighting module and the second lighting module may be disposed between the first flap module and the second flap module.

The first cover flap of the first flap module may include a first surface forming a first corner, a second surface, and a third surface forming a second corner, the second cover flap of the second flap module may include a fourth surface forming a third corner, a fifth surface, and a sixth surface forming a fourth corner, the first lighting module may be disposed behind the first corner of the first cover flap in a state in which the first cover flap opens the inlet hole of the first column and disposed behind the second corner of the first cover flap in a state in which the first cover flap closes the inlet hole of the first column, and the second lighting module may be disposed behind the third corner of the second cover flap in a state in which the second cover flap opens the inlet hole of the second column and disposed behind the fourth corner of the second cover flap in a state in which the second cover flap closes the inlet hole of the second column.

The first lighting module may include a first light source which generates the light and a first diffusion cover which diffuses the first light source, the second lighting module may include a second light source which generates the light and a second diffusion cover which diffuses the second light source, the first light source may be disposed to be spaced apart from the first flap module with the first diffusion cover interposed therebetween, and the second light source may be disposed to be spaced apart from the second flap module with the second diffusion cover interposed therebetween.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a vehicle air flap system according to one embodiment of the present invention;

FIG. 2 is an exploded perspective view illustrating the vehicle air flap system according to one embodiment of the present invention;

FIG. 3 is a perspective view illustrating a first case;

FIG. 4 is a cross-sectional view illustrating the inside of a first accommodation part of the first case;

FIG. 5 is a cross-sectional view illustrating the inside of a second accommodation part of the first case;

FIG. 6 is a view illustrating a first fixing protrusion and a second fixing protrusion of a second case;

FIG. 7 is an exploded perspective view illustrating a flap unit;

FIG. 8 is a front perspective view illustrating a first lens block and a second lens block;

FIG. 9 is a rear perspective view illustrating the first lens block and the second lens block;

FIG. 10 is a view illustrating a state in which a first cover flap is coupled to a first support block and a second cover flap is coupled to a second support block;

FIG. 11 is a view illustrating a state in which the first lens block is coupled to the first support block and the second lens block is coupled to the second support block;

FIG. 12A shows views illustrating portions in which the first lens block of a 1-1 flap module is coupled to the first support block and the second lens block of a 2-1 flap module is coupled to the second support block;

FIG. 12B shows views illustrating portions in which the first lens block of a 1-2 flap module is coupled to the first support block and the second lens block of a 2-2 flap module is coupled to the second support block;

FIG. 13 is a view illustrating a first opening and closing unit;

FIG. 14 is a view illustrating a second opening and closing unit;

FIG. 15 is an exploded perspective view illustrating a first lighting module and a second lighting module;

FIG. 16 is a view illustrating an arrangement relationship between a first light source and the first lens block and an arrangement relationship between a second light source and the second lens block;

FIG. 17 is a view illustrating a state in which a 1-1 flap module closes a first inlet hole and a 2-1 flap module closes a second inlet hole;

FIG. 18 is a view illustrating a state in which the 1-1 flap module opens the first inlet hole and the 2-1 flap module opens the second inlet hole.

FIG. 19 is a view illustrating a state in which a 1-2 flap module closes the first inlet hole and a 2-2 flap module closes the second inlet hole;

FIG. 20 is a view illustrating a state in which the 1-2 flap module opens the first inlet hole and the 2-2 flap module opens the second inlet hole;

FIG. 21 is a view illustrating a transmission path of light generated by the first light source in a state in which the 1-1 flap module or the 2-1 flap module closes the first inlet hole;

FIG. 22 is a view illustrating a transmission path of light generated by the first light source in a state in which the 1-1 flap module or the 2-1 flap module opens the first inlet hole;

FIGS. 23A, 23B and 24 show views illustrating an arrangement relationship between the flap unit and a lighting unit; and

FIG. 25 is a view illustrating a first lens block according to another embodiment.

### DETAILED DESCRIPTION OF EXEMPLARY EMBODIMENTS

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination of a plurality of associated listed items.

When a first element is referred to as being “connected” or “coupled” to a second element, it should be understood that the first element may be directly connected or coupled to the second element, or a third element may be present therebetween. In contrast, when a first element is referred to as being “directly connected” or “directly coupled” to a second element, it will be understood that there are no intervening elements.

In the description of the embodiment, in a case in which any first element is described as being formed on or under a second element, such a description includes both a case in which the two elements are formed in direct contact with each other and a case in which the two elements are in indirect contact with each other with one or more third elements interposed between the two elements. In addition, when a first element is described as being formed on or under a second element, such a description may include a case in which the first element is formed at an upper side or a lower side with respect to the second element.

Terms used herein are for the purpose of describing particular embodiments only and are not intended to limit the present invention. The singular forms are intended to include the plural forms, unless the context clearly indicates otherwise. In the present specification, it should be further understood that the terms “comprise,” “comprising,” “include,” and/or “including,” used herein specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, a vehicle air flap system will be described in detail with reference to the accompanying drawings, and components that are the same or correspond to each other will be denoted by the same reference numerals, and redundant descriptions thereof will be omitted.

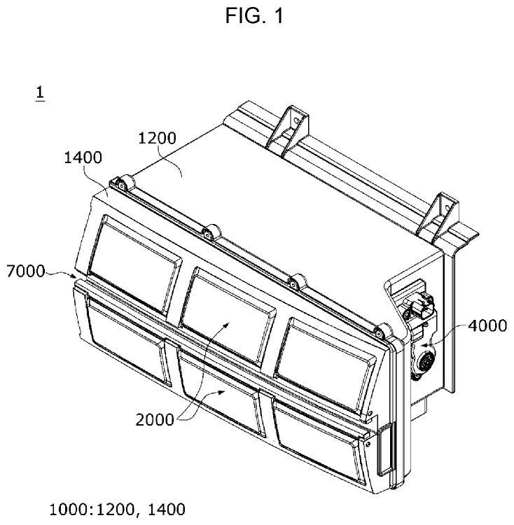

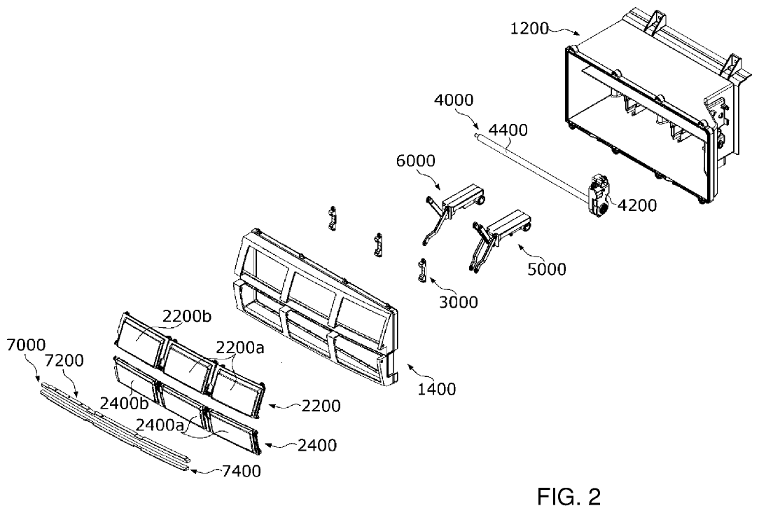

FIG. 1 is a perspective view illustrating a vehicle air flap system according to one embodiment of the present invention, and FIG. 2 is an exploded perspective view illustrating the vehicle air flap system according to one embodiment of the present invention.

Referring to FIGS. 1 and 2, a vehicle air flap system 1 according to one embodiment of the present invention may be disposed on a front portion of a vehicle and allow headwind, which is generated when the vehicle travels, to be introduced into the vehicle or block the headwind. The vehicle air flap system 1 includes a fixing case 1000, a flap unit 2000, a separation prevention block 3000, a rotating unit 4000, and an opening and closing device, and a lighting unit 7000.

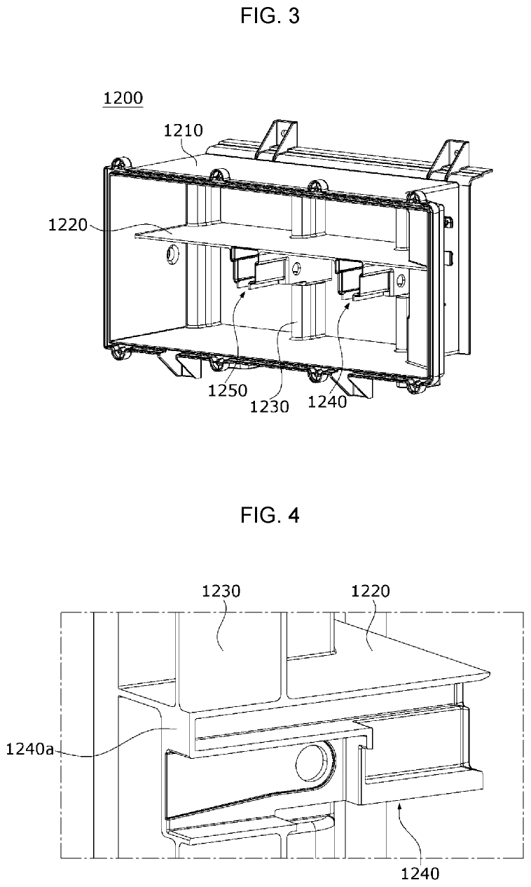

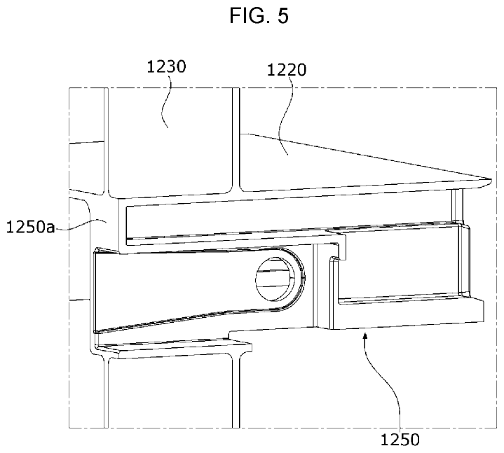

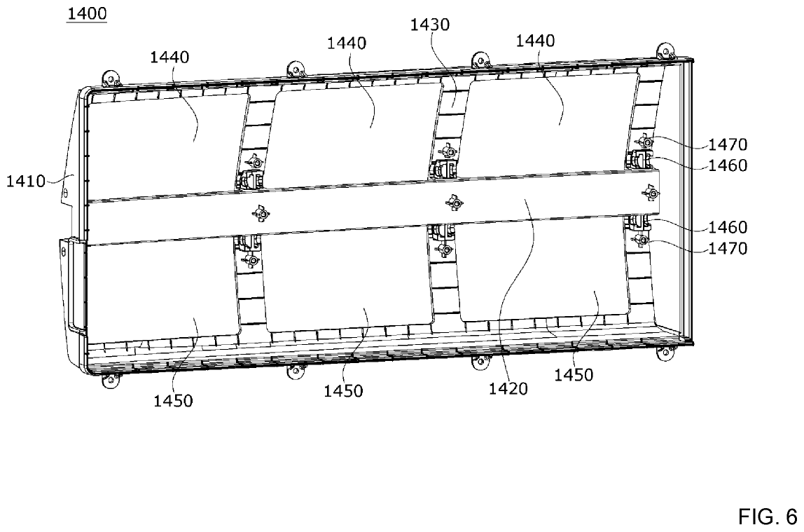

FIG. 3 is a perspective view illustrating a first case, and FIG. 4 is a cross-sectional view illustrating the inside of a first accommodation part of the first case. FIG. 5 is a cross-sectional view illustrating the inside of a second accommodation part of the first case, and FIG. 6 is a view illustrating a first fixing protrusion and a second fixing protrusion of a second case.

Referring to FIGS. 3 to 6, the fixing case 1000 may support components of the vehicle air flap system 1 excluding the fixing case 1000. The fixing case 1000 may include a first case 1200 and a second case 1400.

The first case 1200 may be coupled to the second case 1400 and may support the rotating unit 4000. The first case 1200 may include a first main frame 1210, a first partition frame 1220, a second partition frame 1230, a first accommodation part 1240, and a second accommodation part 1250.

The first main frame 1210 may be a component forming an exterior of the first case 1200. The first main frame 1210 may have a hollow shape to accommodate headwind generated when the vehicle travels. The first main frame 1210 may have a rectangular shape, but is not limited thereto. The first main frame 1210 may be disposed in a width direction intersecting a longitudinal direction from a passenger's room toward an engine room of the vehicle.

The first partition frame 1220 may be disposed in the first main frame 1210 in the width direction. The first partition frame 1220 may divide an internal space of the first main frame 1210. Accordingly, the inside of the first main frame 1210 may be divided into spaces of a first column and a second column in a height direction intersecting the longitudinal direction and the width direction by the first partition frame 1220. Accordingly, two air passing regions may be formed in the first main frame 1210.

The second partition frame 1230 may be disposed in the first main frame 1210. The second partition frame 1230 may be provided as a plurality of second partition frames 1230. The plurality of second partition frames 1230 may be disposed side by side in the width direction. The second partition frames 1230 may divide the internal space of the first main frame 1210. By the second partition frames 1230, the space of the first column of the first main frame 1210 may be divided into a plurality of spaces, and the space of the second column of the first main frame 1210 may be divided into a plurality of spaces.

The first accommodation part 1240 may be supported by the first partition frame 1220 and the second partition frames 1230. The first accommodation part 1240 may accommodate a first moving block 5200 and a first link module 5400, which will be described below, of a first opening and closing unit 5000 therein. The first accommodation part 1240 may be a unit formed of a combination of a plurality of frames, and a plurality of grooves or holes for movably accommodating the first opening and closing unit 5000 may be formed in the first accommodation part 1240. The first accommodation part 1240 may include a first stopper frame 1240a.

The first stopper frame 1240a may be one of the plurality of frames constituting the first accommodation part 1240. The first stopper frame 1240a may close an open one side of the second accommodation part 1250. The first stopper frame 1240a may come into contact with the first moving block 5200, which will be described below, to block the movement of the first moving block 5200.

The second accommodation part 1250 may be supported by the first partition frame 1220 and the second partition frame 1230. The second accommodation part 1250 may movably accommodate a second moving block 6200 and a second link module 6400, which will be described below, of a second opening and closing unit 6000 therein. The second accommodation part 1250 may be a unit formed of a combination of a plurality of frames, and a plurality of grooves of holes for movably accommodating the second opening and closing unit 6000 may be formed in the second accommodation part 1250. The second accommodation part 1250 may include a second stopper frame 1250a.

The second stopper frame 1250a may be one of the plurality of frames constituting the second accommodation part 1250. The second stopper frame 1250a may close an open one side of the second accommodation part 1250. The second stopper frame 1250a may come into contact with the second moving block 6200, which will be described below, to block the movement of the second moving block 6200.

FIG. 6 is a view illustrating the first fixing protrusion and the second fixing protrusion of a second case;

Referring to FIGS. 1, 2, and 6, the second case 1400 may be coupled to the first case 1200. The second case 1400 may include a second main frame 1410, a third partition frame 1420, a fourth partition frame 1430, a first inlet hole 1440, a second inlet hole 1450, a first fixing protrusion 1460, and a second fixing protrusion 1470.

The second main frame 1410 may form an exterior of the second case 1400. The second main frame 1410 may be disposed in the width direction and coupled to the first main frame 1210 of the first case 1200. The second main frame 1410 may be disposed in front of the first case 1200 in the longitudinal direction. The second main frame 1410 may be formed in a hollow quadrangular shape.

The third partition frame 1420 may be disposed in the second main frame 1410. The third partition frame 1420 may divide an internal space of the second main frame 1410. Accordingly, an inner portion of the second main frame 1410 may be divided into spaces of a first column and a second column in the height direction by the third partition frame 1420. Accordingly, two air passing regions may be formed in the second main frame 1410. In addition, the third partition frame 1420 may have a “c” shape whose one and the other sides are bent to form a space therein.

The fourth partition frame 1430 may be disposed in the second main frame 1410. The fourth partition frame 1430 may be provided as a plurality of fourth partition frames 1430. The plurality of fourth partition frames 1430 may be disposed side by side in the width direction. The fourth partition frames 1430 may divide the internal space of the second main frame 1410. The spaces of the first column and the second column of the second main frame 1410 may be divided into a plurality of spaces by the fourth partition frames 1430.

The first inlet hole 1440 may be formed by the third partition frame 1420 and the fourth partition frame 1430. That is, the first inlet hole 1440 may be provided as a plurality of first inlet holes 1440 formed in the second main frame 1410, and the plurality of first inlet holes 1440 may be the spaces of the first column in the second main frame 1410. The first inlet holes 1440 may be the spaces for guiding headwind generated when the vehicle travels into the second main frame 1410 and may be opened or closed by the flap unit 2000.

The second inlet hole 1450 may be formed by the third partition frame 1420 and the fourth partition frame 1430. The second inlet hole 1450 may be provided as a plurality of second inlet holes 1450 formed in the second main frame 1410, and the plurality of second inlet holes 1450 may be the spaces of the second column in the second main frame 1410. The second inlet holes 1450 may be a space for guiding the headwind generated when the vehicle travels to flow into the second main frame 1410 and may be opened or closed by the flap unit 2000.

The first fixing protrusion 1460 may be supported by the third partition frame 1420 and the fourth partition frame 1430. The first fixing protrusion 1460 may rotatably support a first flap module 2200 and a second flap module 2400, which will be described below, of the flap unit 2000. One region of the first fixing protrusion 1460 may be covered by the separation prevention block 3000.

The second fixing protrusion 1470 may protrude from the fourth partition frame 1430. The second fixing protrusion 1470 may be coupled to the separation prevention block 3000 to support the separation prevention block 3000. The second fixing protrusion 1470 may be provided as a plurality of second fixing protrusions 1470, and the plurality of second fixing protrusions 1470 may be disposed to be spaced apart from each other with the third partition frame 1420 interposed therebetween.

As described above, the plurality of inlet holes disposed side by side in each of the first column and the second column may be formed in the fixing case 1000 to allow headwind to be introduced into the vehicle.

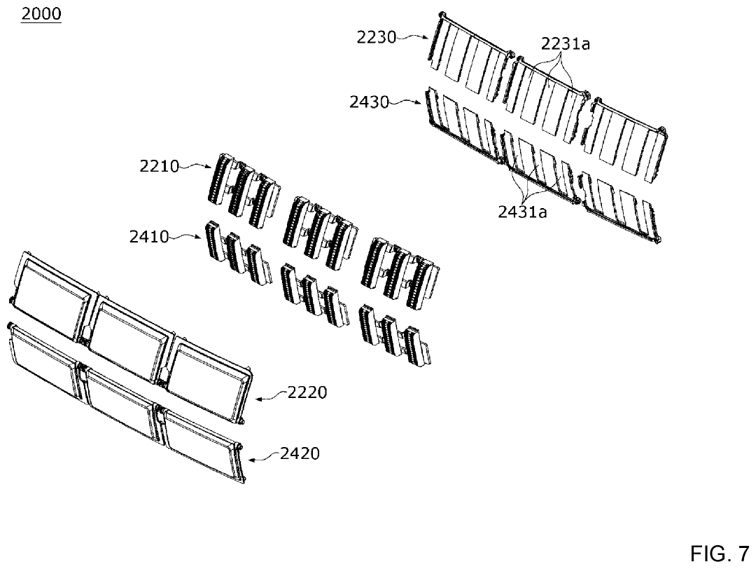

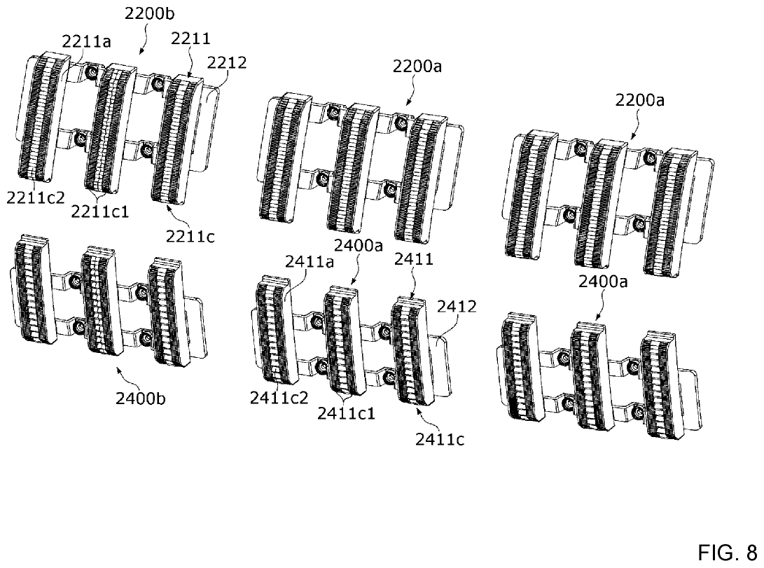

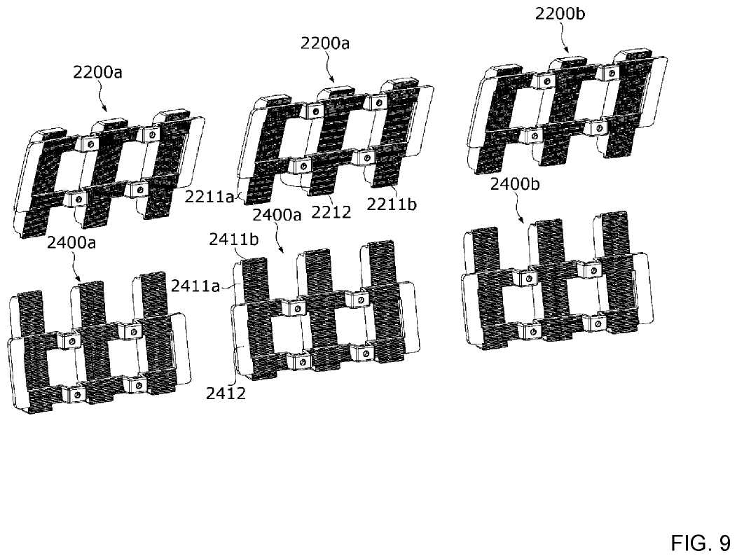

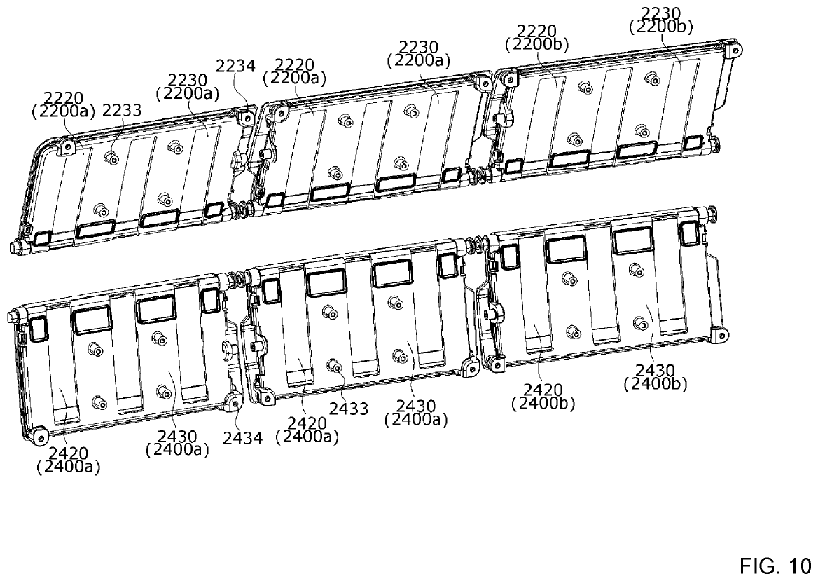

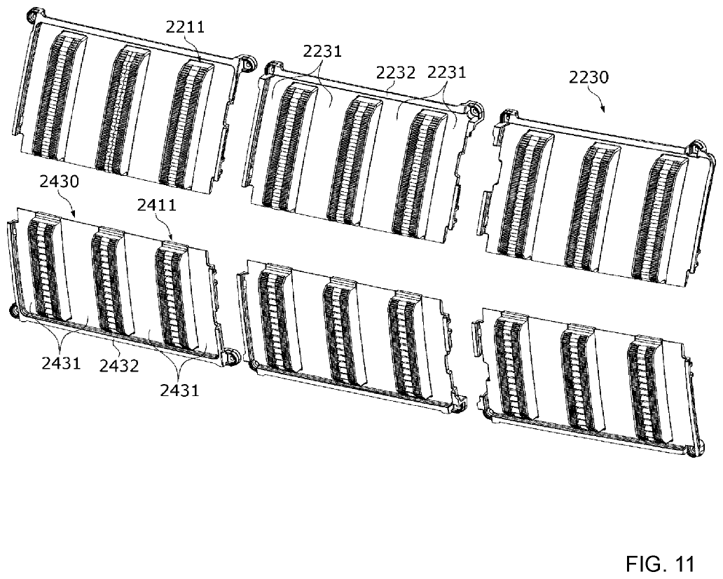

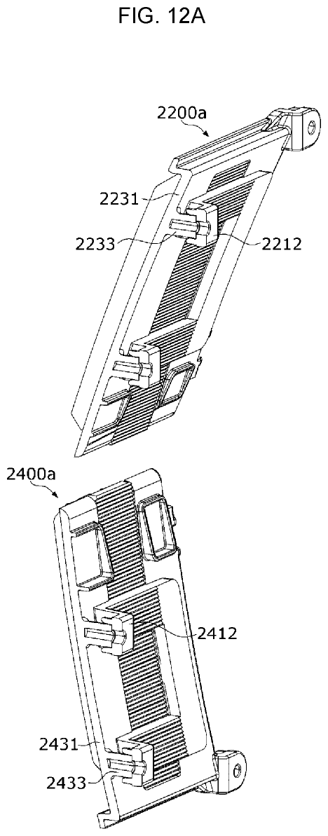

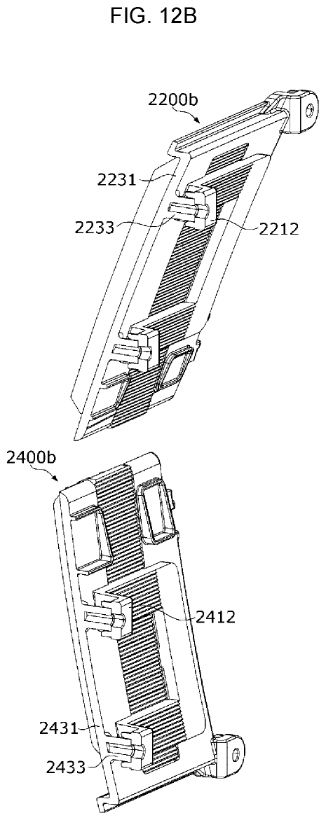

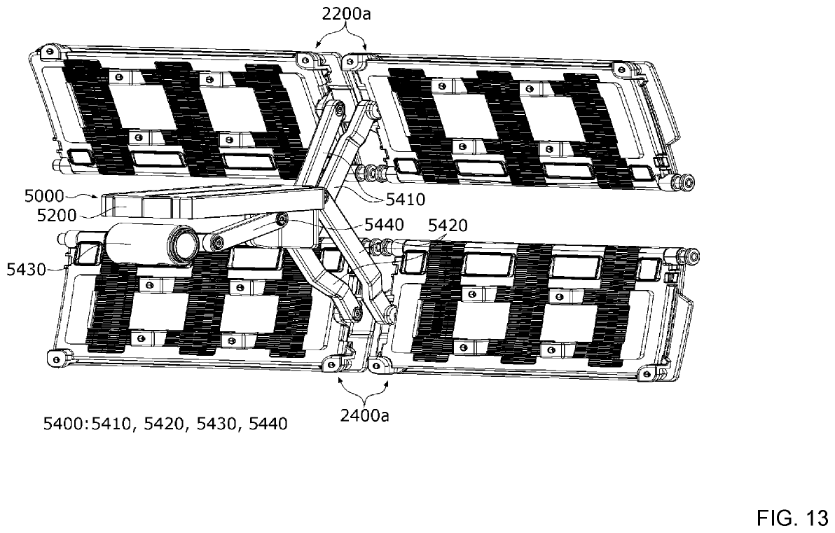

FIG. 7 is an exploded perspective view illustrating the flap unit, and FIG. 8 is a front perspective view illustrating a first lens block and a second lens block. FIG. 9 is a rear perspective view illustrating the first lens block and the second lens block, and FIG. 10 is a view illustrating a state in which a first cover flap is coupled to a first support block and a second cover flap is coupled to a second support block. FIG. 11 is a view illustrating a state in which the first lens block is coupled to the first support block and the second lens block is coupled to the second support block, FIG. 12A shows views illustrating portions in which the first lens block of a 1-1 flap module is coupled to the first support block and the second lens block of a 2-1 flap module is coupled to the second support block, and FIG. 12B shows views illustrating portions in which the first lens block of a 1-2 flap module is coupled to the first support block and the second lens block of a 2-2 flap module is coupled to the second support block.

Referring to FIGS. 1, 2, and 7, the flap unit 2000 may open or close the inlet holes formed in the fixing case 1000. The flap unit 2000 may include the first flap module 2200 disposed in the inlet hole (first inlet hole 1440) of the first column formed and the second flap module 2400 disposed in the inlet hole (second inlet hole 1450) of the second column in the fixing case 1000.

The first flap module 2200 may be disposed in the first inlet hole 1440 formed in the second case 1400. The first flap module 2200 may include a first lens block 2210, a first cover flap 2220, and a first support block 2230. The first flap module 2200 having the above-described configuration is provided as a plurality of first flap modules 2200, and the plurality of first flap modules 2200 are provided with a 1-1 flap module 2200a and a 1-2 flap module 2200b. In this case, the 1-1 flap module 2200a may be coupled to the first opening and closing unit 5000, which will be described below, of the opening and closing device, and the 1-2 flap module 2200b may be coupled to the second opening and closing unit 6000.

Referring to FIGS. 8 and 9, the first lens block 2210 may refract light generated by the lighting unit 7000. The first lens block 2210 may include a first serration body 2211 and a first connecting body 2212

The first serration body 2211 may be provided as a plurality of first serration bodies 2211. The plurality of first serration bodies 2211 may be disposed to be spaced apart from each other in the width direction in each first inlet hole 1440. The first serration body 2211 may include a first base body 2211a, a 1-1 serration part 2211b, and a 1-2 serration part 2211c.

The first base body 2211a may form an exterior of the first serration body 2211. The first base body 2211a may be disposed to be inclined with respect to the first inlet hole 1440. The first base body 2211a may be made of a material with high transmittance that is capable of transmitting light emitted by the lighting unit 7000.

As illustrated in FIG. 9, the 1-1 serration part 2211b may be disposed on an unexposed surface of the first base body 2211a which is not exposed to the outside of the vehicle. The 1-1 serration part 2211b may have an uneven shape in which a convex portion and a concave portion are sequentially alternately disposed. The 1-1 serration part 2211b may serve to refract light emitted by the lighting unit 7000.

The 1-2 serration part 2211c may be disposed on an exposed surface of the first base body 2211a exposed to the outside of the vehicle. The 1-2 serration part 2211c may have an uneven shape in which a convex portion and a concave portion are sequentially alternately disposed. The 1-2 serration part 2211c may transmit light emitted by the lighting unit 7000 or light refracted through the 1-1 serration part 2211b.

The 1-2 serration part 2211c may be provided with first pattern portions 2211c1 provided in a plurality of rows in the width direction and disposed to be spaced apart from each other and a second pattern portion 2211c2 disposed between the plurality of first pattern portions 2211c1. In this case, the first pattern portion 2211c1 may have a unit pattern having the same size as the 1-1 serration part 2211b, and the second pattern portion 2211c2 may have a unit pattern having a greater size than the first pattern portion 2211c1. Accordingly, the first pattern portion 2211c1 and the second pattern portion 2211c2 may have different refractive indexes.

As illustrated in FIG. 9, the first connecting body 2212 may be disposed on the unexposed surface of the first base body 2211a of the first serration body 2211. The first connecting body 2212 may connect the plurality of first serration bodies 2211. As illustrated in FIGS. 12A and 12B, the first connecting body 2212 may be coupled to the first support block 2230.

The first connecting body 2212 may be formed of a combination of connecting parts disposed on the first base bodies 2211a and a non-connecting part disposed between the first base bodies 2211a. Since the connecting part is disposed at a position overlapping the unexposed surface of the first base body 2211a, a plurality of unit patterns, each of which is the same as the 1-1 serration part 2211b are formed in the connecting part, and the plurality of unit patterns may have the same arrangement distance as the 1-1 serration part 2211b. In addition, the non-connecting part may have a shape bent from the connecting parts and connect the connecting parts disposed on each of the first base bodies 2211a. A groove capable of accommodating a portion of the first support block 2230 may be formed in the non-connecting part.

Referring to FIGS. 7 and 10, the first cover flap 2220 may be disposed in front of the first lens block 2210 in the longitudinal direction. The first cover flap 2220 may be rotatably coupled to the fixing case 1000. The first cover flap 2220 may transmit light, which is refracted through the first lens block 2210 and emitted to the outside of the first lens block 2210, to the outside of the first flap module 2200. Accordingly, the first cover flap 2220 may be made of a material with high transmittance to transmit light.

The first cover flap 2220 may be fixedly coupled to the first support block 2230. In addition, the first cover flap 2220 may be connected to the first link module 5400 and the second link module 6400, which will be described below, and rotated to open the first inlet hole 1440 by the first link module 5400 and the second link module 6400. When the first cover flap 2220 is rotated, the first lens block 2210 and the first support block 2230 may be rotated along the first cover flap 2220.

Referring to FIGS. 7 and 10 to 12, the first support block 2230 may be coupled to the first lens block 2210 and the first cover flap 2220 to support the first lens block 2210 and the first cover flap 2220. The first support block 2230 may include a second base body 2231, a second connecting body 2232, a first coupling protrusion 2233, and a second coupling protrusion 2234.

The second base body 2231 may be provided as a plurality of second base bodies 2231. The plurality of second base bodies 2231 may be disposed to be spaced apart from each other in the width direction. Accordingly, a plurality of first placement holes 2231a, in which the first serration bodies 2211 of the first lens block 2210 may be disposed, may be formed between the second base bodies 2231.

The second connecting body 2232 may be disposed on one side of each second base body 2231. The second connecting body 2232 may connect the plurality of second base bodies 2231 to support the plurality of second base bodies 2231. Accordingly, the second connecting body 2232 may close one side of the first placement hole 2231a formed by the plurality of second base bodies 2231.

The first coupling protrusion 2233 may be disposed on the second base body 2231. The first coupling protrusion 2233 may be provided as a plurality of first coupling protrusions 2233. The first coupling protrusion 2233 may be coupled to the first connecting body 2212 of the first lens block 2210. More specifically, the first coupling protrusion 2233 may have a cylindrical shape and may be accommodated in a groove formed in the non-connecting part of the first connecting body 2212.

The second coupling protrusion 2234 may be disposed in a corner region formed by coupling the second base body 2231 and the second connecting body 2232. The second coupling protrusion 2234 may be provided as a plurality of second coupling protrusions 2234. The second coupling protrusion 2234 may be coupled to the first cover flap 2220 to support the first cover flap 2220.

The second flap module 2400 may be disposed in the second inlet hole 1450 formed in the second case 1400. The second flap module 2400 may include a second lens block 2410, a second cover flap 2420, and a second support block 2430. The second flap module 2400 having the above-described configuration may be provided as a plurality of second flap modules 2400, and the plurality of second flap modules 2400 are provided with a 2-1 flap module 2400a and a 2-2 flap module 2400b. In this case, the 2-1 flap module 2400a may be coupled to the first opening and closing unit 5000, which will be described below, and the 2-2 flap module 2400b may be coupled to the second opening and closing unit 6000 of the opening and closing device. The second flap module 2400 may have a shape symmetrical to that of the first flap module 2200.

Referring to FIGS. 8 and 9, the second lens block 2410 may refract light generated by the lighting unit 7000. The second lens block 2410 may include a second serration body 2411 and a third connecting body 2412.

The second serration body 2411 may be provided as a plurality of second serration bodies 2411. The plurality of second serration bodies 2411 may be disposed to be spaced apart from each other in the width direction in each second inlet hole 1450. The second serration body 2411 may include a third base body 2411a, a 2-1 serration part 2411b, and a 2-2 serration part 2411c.

The third base body 2411a may form an exterior of the second serration body 2411. The third base body 2411a may be disposed to be inclined with respect to the second inlet hole 1450. The third base body 2411a may be made of a material with high transmittance that is capable of transmitting light emitted by the lighting unit 7000.

As illustrated in FIG. 9, the 2-1 serration part 2411b may be disposed on an unexposed surface of the third base body 2411a which is not exposed to the outside of the vehicle. The 2-1 serration part 2411b may have an uneven shape in which a convex portion and a concave portion are sequentially alternately disposed. The 2-1 serration part 2411b may serve to refract light emitted by the lighting unit 7000.

The 2-2 serration part 2411c may be disposed on an exposed surface of the third base body 2411a exposed to the outside of the vehicle. The 2-2 serration part 2411c may have an uneven shape in which a convex portion and a concave portion are sequentially alternately disposed. The 2-2 serration part 2411c may transmit light emitted by the lighting unit 7000 or light refracted through the 2-1 serration part 2411b.

The 2-2 serration part 2411c may be provided with third pattern portions 2411c1 provided with a plurality of rows in the width direction and disposed to be spaced apart from each other and a fourth pattern portion 2411c2 disposed between a plurality of third pattern portions 2411c1. In this case, the third pattern portion 2411c1 may have a unit pattern having the same size as the 2-1 serration part 2411b, and the fourth pattern portion 2411c2 may have a unit pattern having a greater size than the third pattern portion 2411c1. Accordingly, the third pattern portion 2411c1 and the fourth pattern portion 2411c2 may have different refractive indexes.

As illustrated in FIG. 9, the third connecting body 2412 may be disposed on the unexposed surface of the third base body 2411a of the second serration body 2411. The third connecting body 2412 may connect the plurality of second serration bodies 2411. As illustrated in FIGS. 12A and 12B, the third connecting body 2412 may be coupled to the second support block 2430.

The third connecting body 2412 may be formed of a combination of connecting parts disposed on the third base bodies 2411a and a non-connecting part disposed between the third base bodies 2411a. Since the connecting part is disposed at a position overlapping the unexposed surface of the third base body 2411a, a plurality of unit patterns, each of which is the same as the 2-1 serration part 2411b, may be formed in the connecting part, and the plurality of unit patterns may have the same arrangement distance as the 2-1 serration part 2411b. In addition, the non-connecting part may have a shape bent from the connecting parts and connect the connecting parts disposed on each of the third base bodies 2411a. A groove capable of accommodating a portion of the second support block 2430 may be formed in the non-connecting part.

Referring to FIGS. 7 and 10, the second cover flap 2420 may be disposed in front of the second lens block 2410 in the longitudinal direction. The second cover flap 2420 may be rotatably coupled to the fixing case 1000. The second cover flap 2420 may transmit light, which is refracted through the first lens block 2210 and externally emitted from the first lens block 2210, to the outside of the second flap module 2400. Accordingly, the second cover flap 2420 may be made of a material with high transmittance to transmit light.

The second cover flap 2420 may be fixedly coupled to the second support block 2430. In addition, the second cover flap 2420 may be connected to the first link module 5400 and the second link module 6400, which will be described below, and rotated to open the second inlet hole 1450 by the first link module 5400 and the second link module 6400. When the second cover flap 2420 rotates, the second lens block 2410 and the second support block 2430 may rotate along the first cover flap 2220.

Referring to FIGS. 7 and 10 to 12, the second support block 2430 may be coupled to the second lens block 2410 and the second cover flap 2420 to support the second lens block 2410 and the second cover flap 2420. The second support block 2430 may include a fourth base body 2431, a fourth connecting body 2432, a third coupling protrusion 2433, and a fourth coupling protrusion 2434.

The fourth base body 2431 may be provided as a plurality of fourth base bodies 2431. The plurality of fourth base bodies 2431 may be disposed to be spaced apart from each other in the width direction. Accordingly, a plurality of second placement holes 2431a in which the second serration bodies 2411 of the second lens block 2410 may be disposed may be formed between the fourth base bodies 2431.

The fourth connecting body 2432 may be disposed on one side of each fourth base body 2431. The fourth connecting body 2432 may connect the plurality of fourth base bodies 2431 to support the plurality of fourth base bodies 2431. Accordingly, the fourth connecting body 2432 may close one side of the second placement hole 2431a formed by each of the plurality of fourth base bodies 2431.

The third coupling protrusion 2433 may be disposed on the fourth base body 2431. The third coupling protrusion 2433 may be provided as a plurality of third coupling protrusions 2433. The third coupling protrusion 2433 may be coupled to the third connecting body 2412 of the second lens block 2410. More specifically, the third coupling protrusion 2433 may have a cylindrical shape and may be accommodated in a groove formed in a non-connecting part of the third connecting body 2412.

The fourth coupling protrusion 2434 may be disposed in a corner region formed by coupling the fourth base body 2431 and the fourth connecting body 2432. The fourth coupling protrusion 2434 may be provided as a plurality of fourth coupling protrusions 2434. The fourth coupling protrusion 2434 may be coupled to the second cover flap 2420 to support the second cover flap 2420.

The separation prevention block 3000 may be provided as a plurality of separation prevention blocks 3000. The plurality of separation prevention blocks 3000 may be coupled to the second fixing protrusions 1470 formed in the second case 1400 of the fixing case. Accordingly, the plurality of separation prevention blocks 3000 may be disposed to be spaced apart from each other in the width direction. Each separation prevention block 3000 may close an open one side of the first fixing protrusion 1460 of the second case 1400. Accordingly, the separation prevention block 3000 may prevent a phenomenon in which each of the flap modules of the flap unit 2000 is separated from the first fixing protrusion 1460.

The rotating unit 4000 may include an actuator 4200, which is connected to an external power supply device and generates power, and a rotating shaft 4400 coupled to the actuator 4200 and rotated by the power generated by the actuator 4200. The actuator 4200 may be coupled to and supported by the first main frame 1210 of the first case 1200 of the fixing case 1000, and the rotating shaft 4400 may be coupled to and rotatably supported by the first main frame 1210, the first accommodation part 1240, and the second accommodation part 1250 of the fixing case 1000.

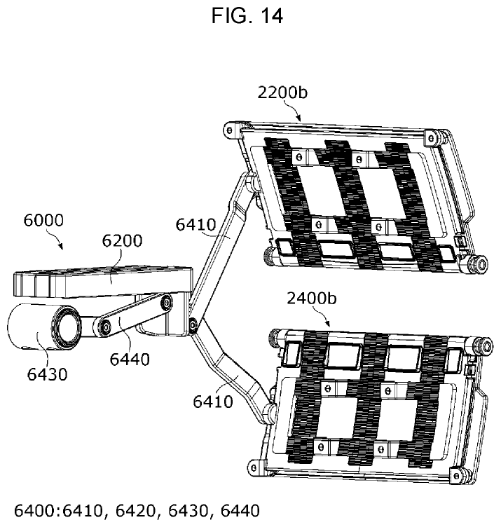

FIG. 13 is a view illustrating the first opening and closing unit, and FIG. 14 is a view illustrating the second opening and closing unit.

The opening and closing device may be disposed in the fixing case 1000. The opening and closing device may include the first opening and closing unit 5000 and the second opening and closing unit 6000 which are connected to the flap unit 2000 and simultaneously rotate the flap unit 2000 disposed in the inlet hole (first inlet hole 1440) of the first column and the inlet hole (second inlet hole 1450) of the second column.

Referring to FIG. 13, the first opening and closing unit 5000 may be connected to the 1-1 flap module 2200a disposed in the first inlet hole 1440 of the fixing case 1000 and connected to the 2-1 flap module 2400a disposed in the second inlet hole 1450. The first opening and closing unit 5000 may include the first moving block 5200 and the first link module 5400.

The first moving block 5200 may rotatably support links of the first link module 5400. The first moving block 5200 may be movably disposed in the first accommodation part 1240 of the first case 1200 of the fixing case 1000 illustrated in FIG. 4. The first moving block 5200 may move a first flap link 5410 and a second flap link 5420, which will be described below, in conjunction with the rotation of the rotating shaft 4400.

The first link module 5400 may include the first flap link 5410, the second flap link 5420, a first shaft link 5430, and a second shaft link 5440.

The first flap link 5410 may be provided as a plurality of first flap links 5410. The plurality of first flap links 5410 may be coupled to the first cover flap 2220 of the 1-1 flap module 2200a. In addition, the first flap link 5410 may be coupled to the first moving block 5200. The first flap link 5410 may rotate the first cover flap 2220 while moving in conjunction with the movement of the first moving block 5200.

The second flap link 5420 may be provided as a plurality of second flap links 5420. The plurality of second flap links 5420 may be coupled to the second cover flap 2420 of the 2-1 flap module 2400a. In addition, the second flap link 5420 may be coupled to the first moving block 5200. The second flap link 5420 may rotate the second cover flap 2420 while moving in conjunction with the movement of the first moving block 5200.

The first shaft link 5430 may be coupled to the rotating shaft 4400. In addition, the first shaft link 5430 may be coupled to the first moving block 5200. When the rotating shaft 4400 rotates, the first shaft link 5430 may be rotated along with the rotating shaft 4400.

The second shaft link 5440 may be coupled to the first shaft link 5430. In addition, the second shaft link 5440 may be coupled to the first moving block 5200. The second shaft link 5440 may generate a force to push or pull the first moving block 5200 in conjunction with the movement of the first shaft link 5430 rotated along with the rotating shaft 4400.

Referring to FIG. 14, the second opening and closing unit 6000 may be connected to the 1-2 flap module 2200b disposed in the second inlet hole 1450 and the 2-2 flap module 2400b disposed in the second inlet hole 1450 of the fixing case 1000. The second opening and closing unit 6000 may include the second moving block 6200 and the second link module 6400.

The second moving block 6200 may rotatably support links of the second link module 6400. The second moving block 6200 may be movably disposed in the second accommodation part 1250 of the first case 1200 of the fixing case 1000 illustrated in FIG. 5. The second moving block 6200 may move a third flap link 6410 and a fourth flap link 6420, which will be described below, in conjunction with the rotation of the rotating shaft 4400.

The second link module 6400 may include the third flap link 6410, the fourth flap link 6420, a third shaft link 6430, and a fourth shaft link 6440.

The third flap link 6410 may be coupled to the first cover flap 2220 of the 1-2 flap module 2200b. In addition, the third flap link 6410 may be coupled to the second moving block 6200. The third flap link 6410 may rotate the first cover flap 2220 while moving in conjunction with the movement of the second moving block 6200.

The fourth flap link 6420 may be coupled to the second cover flap 2420 of the 2-2 flap module 2400b. In addition, the fourth flap link 6420 may be coupled to the second moving block 6200. The fourth flap link 6420 may rotate the second cover flap 2420 while moving in conjunction with the movement of the second moving block 6200.

The third shaft link 6430 may be coupled to the rotating shaft 4400. In addition, the third shaft link 6430 may be coupled to the second moving block 6200. When the rotating shaft 4400 rotates, the third shaft link 6430 may be rotated along with the rotating shaft 4400.

The fourth shaft link 6440 may be coupled to the third shaft link 6430. In addition, the fourth shaft link 6440 may be coupled to the second moving block 6200. The fourth shaft link 6440 may generate a force to push or pull the second moving block 6200 in conjunction with the movement of the third shaft link 6430 rotated along with the rotating shaft 4400.

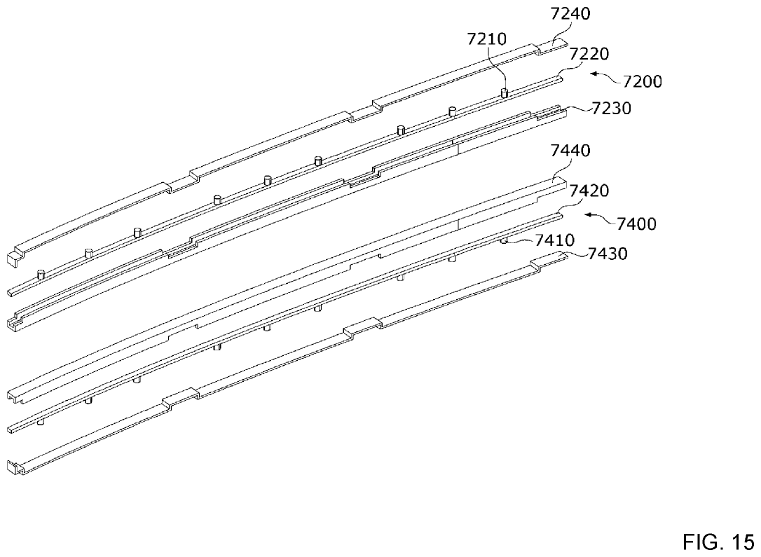

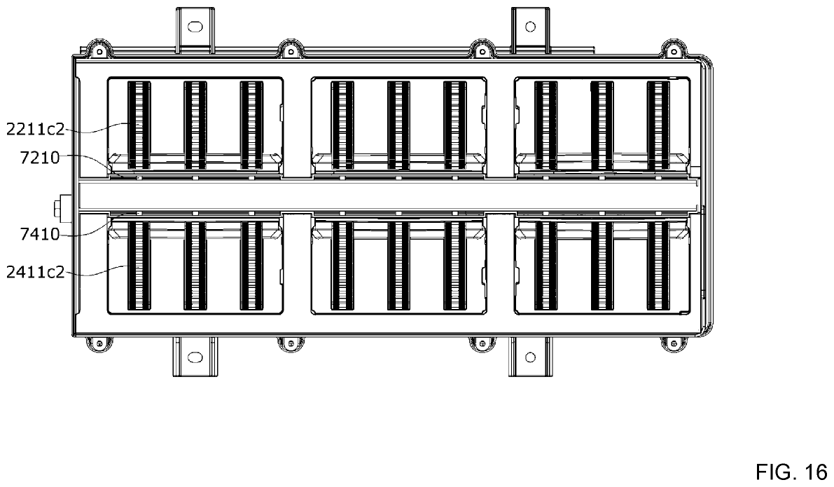

FIG. 15 is an exploded perspective view illustrating a first lighting module and a second lighting module, and FIG. 16 is a view illustrating an arrangement relationship between a first light source and the first lens block and an arrangement relationship between a second light source and the second lens block.

Referring to FIGS. 1, 2, and 15, the lighting unit 7000 may be disposed in the third partition frame 1420 of the second case 1400 of the fixing case 1000. The lighting unit 7000 may include a first lighting module 7200 and a second lighting module 7400 each including a light source which emits light toward the flap unit 2000. The first lighting module 7200 and the second lighting module 7400 may be disposed between the first flap module 2200 and the second flap module 2400. That is, the lighting unit 7000 may emit light toward the flap unit 2000 and illuminate the flap unit 2000 to improve the designability of a front side of the vehicle.

The first lighting module 7200 may be disposed close to the first flap module 2200. The first lighting module 7200 may be disposed in the width direction. The first lighting module 7200 may include the first light source 7210, a first substrate 7220, a first housing 7230, and a first diffusion cover 7240.

The first light source 7210 may be coupled to the first substrate 7220 and may generate light in response to a control signal generated by the first substrate 7220. The first light source 7210 may include a light-emitting diode (LED). The first substrate 7220 may be coupled to the first light source 7210 to support the first light source 7210. The first substrate 7220 may be a printed circuit board.

The first housing 7230 may have a hollow shape. The first housing 7230 may accommodate the first light source 7210 and the first substrate 7220 therein. In addition, the first housing 7230 may have a shape whose one side is open to allow light generated by the first light source 7210 to move.

The first diffusion cover 7240 may be coupled to the first housing 7230. The first diffusion cover 7240 may be made of a material with high transmittance to transmit light generated by the first light source 7210. The first diffusion cover 7240 may cover an open one side of the first housing 7230. The first diffusion cover 7240 may be disposed to face the first flap module 2200.

The second lighting module 7400 may be disposed close to the second flap module 2400. The second lighting module 7400 may be disposed to be spaced apart from the first lighting module 7200 and have a shape symmetrical to that of the first lighting module 7200. The second lighting module 7400 may be disposed in the width direction. The second lighting module 7400 may include a second light source 7410, a second substrate 7420, a second housing 7430, and a second diffusion cover 7440.

The second light source 7410 may be coupled to the second substrate 7420 and may generate light in response to a control signal generated by the second substrate 7420. The second light source 7410 may include an LED. The second substrate 7420 may be coupled to the second light source 7410 to support the second light source 7410. The second substrate 7420 may be a printed circuit board.

The second housing 7430 may have a hollow shape. The second housing 7430 may accommodate the second light source 7410 and the second substrate 7420 therein. In addition, the second housing 7430 may have a shape whose one side is open to allow light generated by the second light source 7410 to move.

The second diffusion cover 7440 may be coupled to the second housing 7430. The second diffusion cover 7440 may be made of a material with high transmittance to transmit light generated by the second light source 7410. The second diffusion cover 7440 may cover an open one side of the second housing 7430. The second diffusion cover 7440 may be disposed to face the second flap module 2400.

Referring to FIG. 16, the light source of the lighting unit 7000 may be disposed to face the second pattern portion 2211c2 of the first lens block 2210 of the first flap module 2200 and the fourth pattern portion 2411c2 of the second lens block 2410 of the second flap module 2400.

More specifically, the first light source 7210 of the first lighting module 7200 may be provided as a plurality of first light sources 7210, and the plurality of first light sources 7210 may be disposed to be spaced apart from each other in the width direction. In this case, the plurality of first light sources 7210 may be spaced apart from each other by a distance that is the same as a distance by which the plurality of first lens blocks 2210 are spaced apart from each other, and each of the first light sources 7210 may be disposed at a position to face the second pattern portion 2211c2 of the first lens block 2210.

In addition, the second light source 7410 of the second lighting module 7400 may be provided as a plurality of second light sources 7410, and the plurality of second light sources 7410 may be disposed to be spaced apart from each other in the width direction. In this case, the plurality of second light sources 7410 may be spaced apart from each other by a distance that is the same as a distance by which the plurality of second lens blocks 2410 are spaced apart from each other, and each of the second light sources 7410 may be disposed at a position to face the fourth pattern portion 2411c2 of the second lens block 2410.

The above-described layout of the light sources is for minimizing loss of light illuminating the flap unit 2000 to prevent the degradation of the designability of the front side of the vehicle.

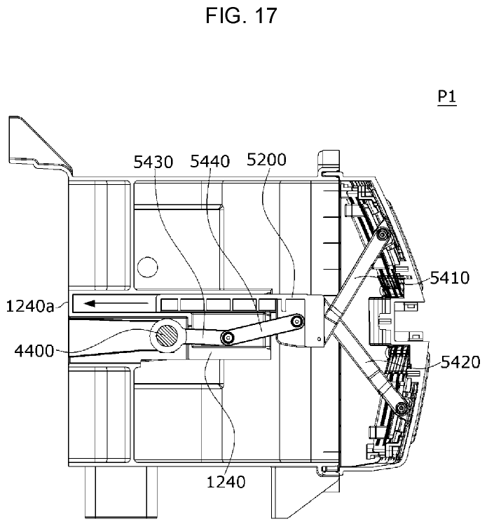

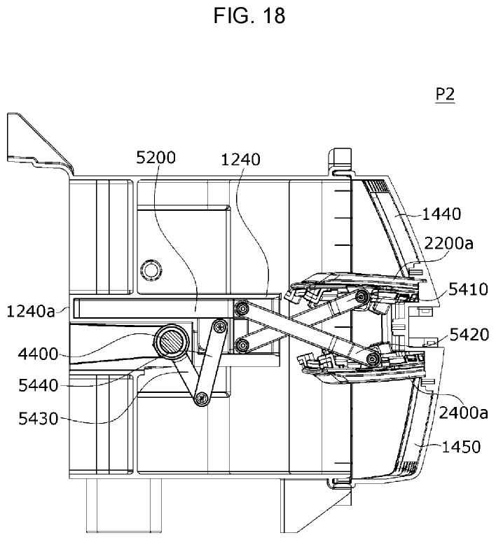

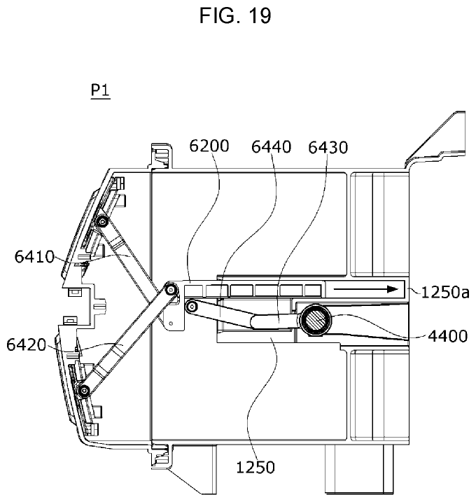

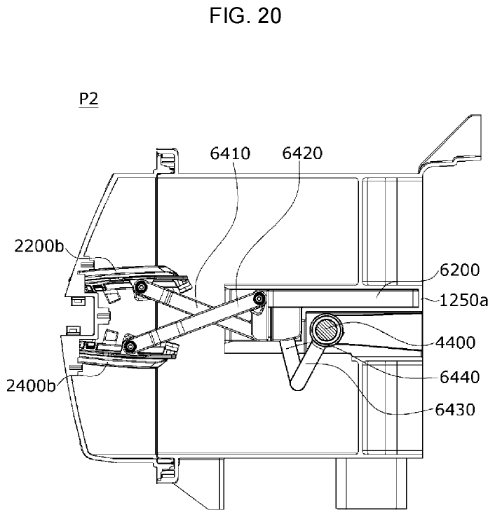

FIG. 17 is a view illustrating a state in which the 1-1 flap module closes the first inlet hole and the 2-1 flap module closes the second inlet hole, and FIG. 18 is a view illustrating a state in which the 1-1 flap module opens the first inlet hole and the 2-1 flap module opens the second inlet hole. FIG. 19 is a view illustrating a state in which the 1-2 flap module closes the first inlet hole and the 2-2 flap module closes the second inlet hole, and FIG. 20 is a view illustrating a state in which the 1-2 flap module opens the first inlet hole and the 2-2 flap module opens the second inlet hole.

Referring to FIGS. 17 and 18, first, the 1-1 flap module 2200a and the 2-1 flap module 2400a are located at a first position P1 at which the first inlet hole 1440 and the second inlet hole 1450 are closed.

In this state, when the rotating shaft 4400 is rotated by the actuator 4200, the first shaft link 5430 of the first opening and closing unit 5000 coupled to the rotating shaft 4400 is rotated along with the rotating shaft 4400, and the first shaft link 5430 generates a force that pulls the second shaft link 5440 toward rotating shaft 4400. Accordingly, the second shaft link 5440 moves toward the rotating shaft 4400, and the second shaft link 5440 pulls the first moving block 5200. Accordingly, the first moving block 5200 moves toward the rotating shaft 4400.

Since the first moving block 5200 is in a state of being movably accommodated in the first accommodation part 1240 of the fixing case 1000, the first moving block 5200 moves toward the rotating shaft 4400 in the first accommodation part 1240. In this case, since the first moving block 5200 moves, the first flap link 5410 and the second flap link 5420 connected to the first moving block 5200 are pulled by the first moving block 5200. In this case, the first flap link 5410 and the second flap link 5420 rotate to be close to each other.

Accordingly, the 1-1 flap module 2200a coupled to the first flap link 5410 may rotate to open the first inlet hole 1440, and the 2-1 flap module 2400a coupled to the second flap link 5420 may rotate to open the second inlet hole 1450 so that the 1-1 flap module 2200a and the 2-1 flap module 2400a may be disposed at a second position P2. Accordingly, the first inlet hole 1440 and the second inlet hole 1450 are opened. Meanwhile, the first moving block 5200 comes into contact with the first stopper frame 1240a of the first accommodation part 1240 of the fixing case 1000 and is blocked from moving.

Referring to FIGS. 19 and 20, then, the 1-2 flap module 2200b and the 2-2 flap module 2400b are disposed at the first position P1 at which the first inlet hole 1440 and the second inlet hole 1450 are closed.

In this state, when the rotating shaft 4400 is rotated by the actuator 4200, the third shaft link 6430 of the second opening and closing unit 6000 coupled to the rotating shaft 4400 is rotated along with the rotating shaft 4400, and the third shaft link 6430 generates a force that pulls the fourth shaft link 6440 toward rotating shaft 4400. Accordingly, the fourth shaft link 6440 moves toward the rotating shaft 4400, and the fourth shaft link 6440 pulls the second moving block 6200. Accordingly, the second moving block 6200 moves toward the rotating shaft 4400.

Since the second moving block 6200 is in a state of being movably accommodated in the second accommodation part 1250 of the fixing case 1000, the second moving block 6200 moves toward the rotating shaft 4400 in the second accommodation part 1250. In this case, since the second moving block 6200 moves, the third flap link 6410 and the fourth flap link 6420 connected to the second moving block 6200 are pulled by the second moving block 6200. In this case, the third flap link 6410 and the fourth flap link 6420 rotate to be close to each other.

Accordingly, the 1-2 flap module 2200b coupled to the third flap link 6410 may rotate to open the first inlet hole 1440, and the 2-2 flap module 2400b coupled to the fourth flap link 6420 may rotate to open the second inlet hole 1450 so that the 1-2 flap module 2200b and the 2-2 flap module 2400b may be disposed at the second position P2. Accordingly, the first inlet hole 1440 and the second inlet hole 1450 are opened. Meanwhile, the second moving block 6200 comes into contact with the second stopper frame 1250a of the second accommodation part 1250 of the fixing case 1000 and is blocked from moving.

As described above, the vehicle air flap system 1 according to one embodiment of the present invention may open the plurality of inlet holes disposed in the height direction at one time.

Hereinafter, a state in which the flap unit 2000 is illuminated according to a transmission path of light will be described.

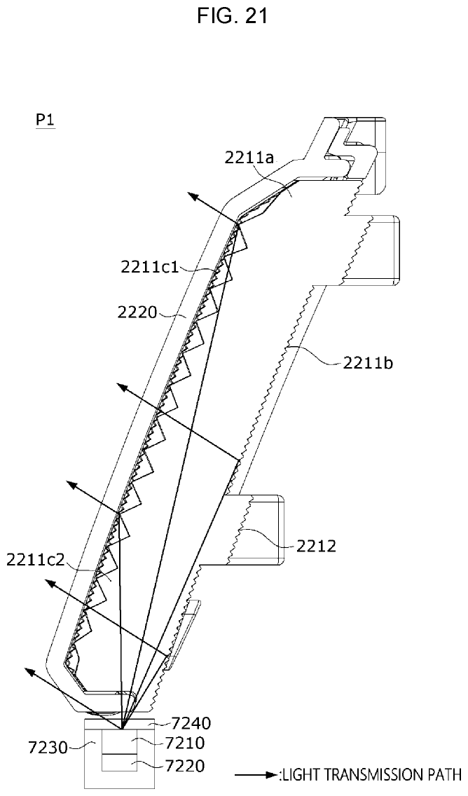

FIG. 21 is a view illustrating a transmission path of light generated by the first light source in a state in which the 1-1 flap module or the 2-1 flap module closes the first inlet hole.

Light generated by the lighting unit 7000 may be refracted through the first serration body 2211 and the second serration body 2411 of the flap unit 2000 and emitted to the outside of the flap unit 2000. In the present embodiment, an example in which light is emitted though the first serration body 2211 will be described.

Referring to FIGS. 21, in a state in which the 1-1 flap module 2200a or the 2-1 flap module 2400a is disposed at the first position P1 at which the first inlet hole is closed, when light is generated by the first light source 7210 of the first lighting module 7200, the light may pass through the first cover flap 2220 and the first serration body 2211 and pass through the first flap module 2200 to the outside.

More specifically, first, light which passes through the first diffusion cover 7240 and enters the first base body 2211a of the first serration body 2211 moves toward the 1-1 serration part 2211b. The light which moves toward the 1-1 serration part 2211b collides with the 1-1 serration part 2211b and then is refracted therethrough to move toward the 1-2 serration part 2211c. The light moved toward the 1-2 serration part 2211c passes through the first pattern portion 2211c1 or the second pattern portion 2211c2. The light refracted while passing through the first pattern portion 2211c1 or the second pattern portion 2211c2 ultimately passes through the first cover flap 2220 and moves to the outside of the first flap module 2200.

Then, light which passes through the first diffusion cover 7240 and enters the first base body 2211a of the first serration body 2211 moves toward the 1-2 serration part 2211c. The light which moves toward the 1-2 serration part 2211c passes through the first pattern portion 2211c1 or the second pattern portion 2211c2. The light refracted while passing through the first pattern portion 2211c1 or the second pattern portion 2211c2 may ultimately pass through the first cover flap 2220 and move to the outside of the first flap module 2200.

Then, the light which passes through the first diffusion cover 7240 passes through the first cover flap 2220 instead of the first serration body 2211 and ultimately moves to the outside of the first flap module 2200.

As described above, the light is diffused while colliding with the plurality of serration parts and is diffused to an entire region of the first flap module 2200. Accordingly, since light generated by the first light source 7210 illuminates the first flap module 2200 through various paths, when the first flap module 2200 closes the first inlet hole 1440 of the fixing case 1000, the designability of the front side of the vehicle can be improved.

In the present embodiment, the example in which light is transmitted through the first serration body 2211 has been described, but is not limited thereto. Since the second flap module 2400 and the second lighting module 7400 have shapes symmetrical to those of the first flap module 2200 and the first lighting module 7200, light which moves in the inner portion of the second flap module 2400 may be transmitted from the inside to the outside of the second flap module 2400 by the same principle.

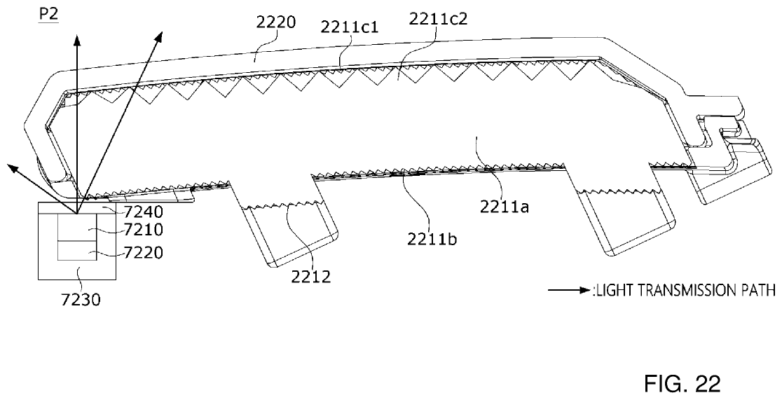

FIG. 22 is a view illustrating a transmission path of light generated by the first light source in a state in which the 1-1 flap module or the 2-1 flap module opens the first inlet hole.

Referring to FIG. 22, in a state in which the 1-1 flap module 2200a or the 2-1 flap module 2400a is disposed at the second position P2 at which the first inlet hole 1440 is opened, light generated by the first light source 7210 may not pass through an inner portion of the 1-1 flap module 2200a or an inner portion of the 2-1 flap module 2400a. In addition, the light may pass through only a region in which the 1-1 flap module 2200a overlaps the first lighting module 7200 and a region adjacent to the region in which the 1-1 flap module 2200a overlaps the first lighting module 7200, and may pass through a region in which the 2-1 flap module 2400a overlaps the first lighting module 7200 and a region adjacent to the region in which the 2-1 flap module 2400a overlaps the first lighting module 7200.

The reason for having the above-described structure is that, in a state in which the 1-1 flap module 2200a or the 2-1 flap module 2400a opens the first inlet hole 1440, an inner portion of the fixing case 1000 may be visible due to light emitted by the first light source 7210. Accordingly, in the state in which the 1-1 flap or the 2-1 flap opens the first inlet hole 1440 to prevent the inner portion of the fixing case 1000 from being visible due to the light emitted by the first light source 7210, movement may be performed in the range in which a transmission path of light is limited.

In the present embodiment, relationships between the 1-1 flap module 2200a, the 2-1 flap module 2400a, and the first lighting module 7200 have been described but are not limed thereto, and may be equally applied to relationships between the 1-2 flap module 2200b, the 2-2 flap module 2400b, and the second lighting module 7400.

As described above, referring to FIGS. 21 and 22, when the flap unit 2000 closes the inlet hole of the first column and the inlet hole of the second column, the flap unit 2000 is illuminated by light generated by the lighting unit 7000, and when the flap unit 2000 opens the inlet hole of the first column and the inlet hole of the second column, the flap unit 2000 may not be illuminated. Accordingly, the vehicle air flap system 1 of the present embodiment may prevent the degradation of the aesthetics by preventing degradation of the designability of the front side of the vehicle.

Hereinafter, an arrangement relationship between the flap unit 2000 and the lighting unit 7000 will be described.

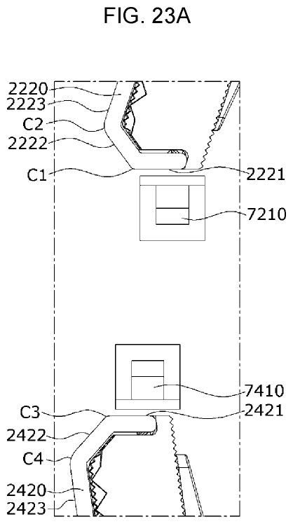

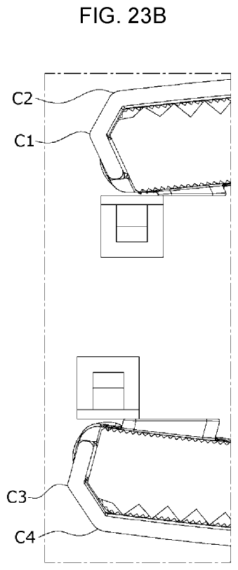

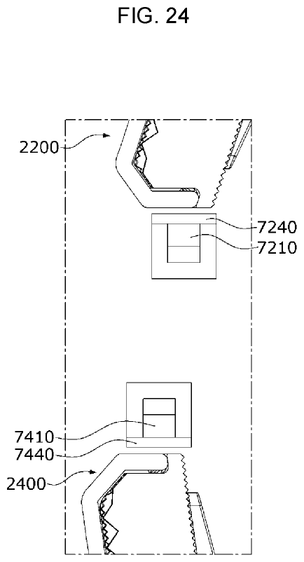

FIGS. 23A, 23B and 24 shows views illustrating an arrangement relationship between the flap unit and a lighting unit.

Referring to FIGS. 23A and 23B, the first cover flap 2220 of the first flap module 2200 may include a first surface 2221 forming a first corner C1, a second surface 2222, and a third surface 2223 forming a second corner C2 together with the second surface 2222. In addition, the second cover flap 2420 of the second flap module 2400 may include a fourth surface 2421 forming a third corner C3, a fifth surface 2422, and a sixth surface 2423 forming a fourth corner C4 along with the fifth surface 2422.

In this case, as in FIG. 23B, the first lighting module 7200 may be disposed behind the first corner C1 of the first cover flap 2220 in a state in which the first cover flap 2220 opens the first inlet hole 1440 and disposed behind the second corner C2 of the first cover flap 2220 in a state in which the first cover flap 2220 closes the first inlet hole 1440.

In addition, as in FIG. 23A, the second lighting module 7400 may be disposed behind the third corner C3 of the second cover flap 2420 in a state in which the second cover flap 2420 opens the second inlet hole 1450 and disposed behind the fourth corner C4 of the second cover flap 2420 in a state in which the second cover flap 2420 closes the second inlet hole 1450.

This is for preventing light generated by the first light source 7210 and the second light source 7410 from diffusing to the outside of the first cover flap 2220 and the second cover flap 2420 by preventing the light from escaping from the first cover flap 2220 and the second cover flap 2420 in a state in which the first flap module 2200 and the second flap module 2400 close the first inlet holes 1440. Accordingly, the designability of the front side of the vehicle can be prevented.

In addition, this is for preventing the degradation of the designability of the front side of the vehicle by preventing the first light source 7210 and the second light source 7410 from being exposed to the outside of the first flap module 2200 and the second flap module 2400 in a state in which the first flap module 2200 and the second flap module 2400 open the first inlet holes 1440.

Referring to FIG. 24. The first light source 7210 may be disposed to be spaced apart from the first flap module 2200 with the first diffusion cover 7240 interposed therebetween, and the second light source 7410 may be disposed to be spaced apart from the second flap module 2400 with the second diffusion cover 7440 interposed therebetween. This is for securing distances in which light emitted by the first light source 7210 and the second light source 7410 may be sufficiently diffused to the first flap module 2200 and the second flap module 2400.

To this end, a distance between the first flap module 2200 and the first light source 7210 is preferably set to be in the range of 8 mm to 10 mm. This is because, when the distance between the first flap module 2200 and the first light source 7210 and a distance between the second flap module 2400 and the second light source 7410 are 8 mm or less, since a phenomenon, in which light is concentrated on and combined in a region at which the first flap module 2200 and the second flap module 2400 come into contact with each other, may occur, a problem that only a specific region is shined may occur. In addition, this is because, when the distance between the first flap module 2200 and the first light source 7210 and the distance between the second flap module 2400 and the second light source 7410 are 10 mm or more, a problem that light escapes from the first flap module 2200 and the second flap module 2400 to not illuminate the first flap module 2200 and the second flap module 2400, or the first flap module 2200 and the second flap module 2400 are dimly illuminated occurs.

In addition, the reason why the first light source 7210 is disposed to be spaced apart from the first flap module 2200 with the first diffusion cover 7240 interposed therebetween and the second light source 7410 is disposed to be spaced apart from the second flap module 2400 with the second diffusion cover 7440 interposed therebetween is for preventing collision with the first lighting module 7200 and the second lighting module 7400 when the first flap module 2200 and the second flap module 2400 rotate. To this end, a distance between the first flap module 2200 and the first diffusion cover and a distance between the second flap module 2400 and the second diffusion cover are preferably set to 2 mm or more.

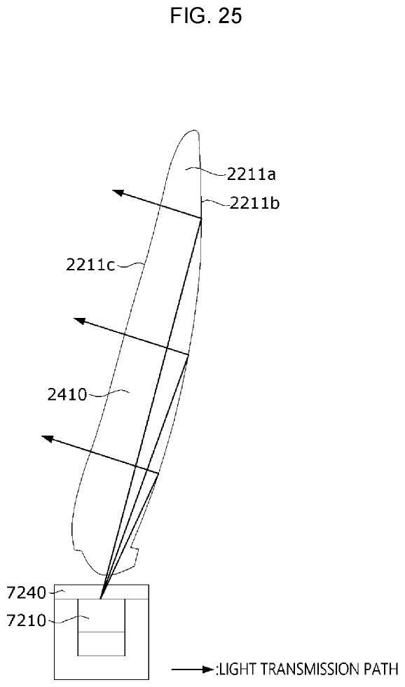

FIG. 25 is a view illustrating a first lens block according to another embodiment.

Referring to FIG. 25, a 1-1 serration part 2211b of a first flap module 2200 may have a shape whose cross section gradually decreases from a lower side toward an upper side in a height direction. This is for reducing a vertical distance with respect to light emitted by a first light source 7210 to allow the light to reach an upper end portion of the 1-1 serration part 2211b in the height direction.

According to one embodiment of the present invention, since a flap is not disposed behind a cover, the degradation of the designability of a front side of a vehicle can be prevented.

In addition, according to one embodiment of the present invention, since a flap unit can be illuminated by a lighting unit, the designability of a front side of a vehicle can be improved.

While the present invention has been described above with reference to exemplary embodiments, it may be understood by those skilled in the art that various modifications and changes of the present invention may be made within a range not departing from the spirit and scope of the present invention defined by the appended claims. In addition, it should be interpreted that differences related to the modifications and changes fall within the scope of the present invention defined by the appended claims.

What is claimed is:

1. A vehicle air flap system comprising:
a fixing case comprising a plurality of inlet holes located side by side in a first column and a second column;
flap units located in the inlet hole of the first column and the inlet hole of the second column;
an opening and closing device connected to the flap units and comprising a first opening and closing unit and a second opening and closing unit which are configured to simultaneously rotate the flap units located in the inlet hole of the first column and the inlet hole of the second column; and
a lighting unit comprising a light source located at one side of the flap units and configured to emit light toward the flap units.

2. The vehicle air flap system of claim 1, wherein:
when the flap units close the inlet hole of the first column and the inlet hole of the second column, the flap units are illuminated by the light generated by the lighting unit; and
when the flap units open the inlet hole of the first column and the inlet hole of the second column, the flap units are not illuminated.

3. The vehicle air flap system of claim 1, wherein:
the flap units comprise a first flap module located in the inlet hole of the first column; and
the first flap module comprises a first lens block configured to reflect the light generated by the lighting unit, a first cover flap rotatably coupled to the fixing case, and a first support block coupled to the first lens block and the first cover flap to support the first lens block and the first cover flap.

4. The vehicle air flap system of claim 3, wherein:
the first lens block comprises a plurality of first serration bodies; and
each of the first serration bodies comprises a 1-1 serration part located on an unexposed surface and configured to refract the light emitted by the lighting unit and a 1-2 serration part located on an exposed surface and configured to emit the light emitted by the lighting unit or the light refracted through the 1-1 serration part.

5. The vehicle air flap system of claim 4, wherein:
the flap units comprise a second flap module located in the inlet hole of the second column; and
the second flap module comprises a second lens block configured to refract the light generated by the lighting unit, a second cover flap coupled to the second lens block and rotatably coupled to the fixing case, and a second support block coupled to the second lens block and the second cover flap to support the second lens block and the second cover flap.

6. The vehicle air flap system of claim 5, wherein:
the second lens block comprises a plurality of second serration bodies; and
each of the second serration bodies comprises a 2-1 serration part located on an unexposed surface and configured to refract the light emitted by the lighting unit and a 2-2 serration part located on an exposed surface and configured to refract the light emitted by the lighting unit or the light refracted through the 2-1 serration part.

7. The vehicle air flap system of claim 6, wherein:
the 1-2 serration part of the first serration body comprises a plurality of first pattern portions spaced apart from each other and a second pattern portion located between the plurality of first pattern portions;
the 2-2 serration part of the second serration body comprises a plurality of third pattern portions and a fourth pattern portion located between the plurality of third pattern portions; and
the light source of the lighting unit faces the second pattern portion and the fourth pattern portion.

8. The vehicle air flap system of claim 5, wherein the lighting unit comprise:
a first lighting module located near the first flap module; and
a second lighting module located near the second flap module,
wherein the first lighting module and the second lighting module are located between the first flap module and the second flap module.

9. The vehicle air flap system of claim 8, wherein:
the first cover flap of the first flap module comprises a first surface forming a first corner, a second surface, and a third surface forming a second corner;
the second cover flap of the second flap module comprises a fourth surface forming a third corner, a fifth surface, and a sixth surface forming a fourth corner;
the first lighting module is located behind the first corner of the first cover flap in a state in which the first cover flap opens the inlet hole of the first column and located behind the second corner of the first cover flap in a state in which the first cover flap closes the inlet hole of the first column; and
the second lighting module is located behind the third corner of the second cover flap in a state in which the second cover flap opens the inlet hole of the second column and located behind the fourth corner of the second cover flap in a state in which the second cover flap closes the inlet hole of the second column.

10. The vehicle air flap system of claim 8, wherein:
the first lighting module comprises a first light source configured to generate the light and a first diffusion cover configured to diffuse the first light source;
the second lighting module comprises a second light source configured to generate the light and a second diffusion cover configured to diffuse the second light source;
the first light source is located to be spaced apart from the first flap module with the first diffusion cover interposed therebetween; and
the second light source is located to be spaced apart from the second flap module with the second diffusion cover interposed therebetween.
